(19) United States
(12) Patent Application Publication
(10) Pub. No.: US 2025/0094703 A1
(43) Pub. Date: Mar. 20, 2025

(54) AI-GENERATED DATA OBJECTS FOR DATA VISUALIZATION

(71) Applicant: Oracle International Corporation, Redwood City, CA (US)

(72) Inventors: Michael Senada Malak, Sarasota, FL (US); Monisha Balaji, Redwood City, CA (US); Leon Eli Militao Carvalho, Barnet (GB)

(21) Appl. No.: 18/508,805

(22) Filed: Nov. 14, 2023

Related U.S. Application Data
(60) Provisional application No. 63/583,396, filed on Sep. 18, 2023.

(51) Int. Cl. G06F 40/20

(52) U.S. Cl. CPC G06F 40/20

(57) ABSTRACT

Technology is disclosed herein for generating a visualization of data based on an AI-generated data object. In an implementation, an application, such as a data analytics application, receives a natural language input from a user which relates to a table of data in the application. The table includes data organized according to table columns. The application generates a prompt for a large language model (LLM) service which includes the names of the table columns. The prompt tasks the LLM service with selecting columns for the visualization based on the natural language input and the names of the table columns. The prompt tasks the LLM service with generating a response in a JSON format. The application populates the JSON object, which describes the visualization, according to the response. The application then creates visualization based on the JSON object.

### CROSS REFERENCE TO RELATED APPLICATIONS

This application is related to U.S. Patent Application entitled “AI-GENERATED DATA OBJECTS FOR DATA VISUALIZATION,” filed Sep. 18, 2023 under Application No. 63/583,396, the contents of which are incorporated by reference in their entirety for all purposes.

### TECHNICAL FIELD

Aspects of the disclosure are related to generating visualizations of datasets for data analysis.

### BACKGROUND

To generate a visualization for a dataset, in spreadsheet and data analysis applications, the user may navigate a menu of choices including selecting which data to plot, what type of plot to generate, and a number of other options which relate to how the data is displayed as well as to aesthetics and readability considerations. This paradigm of data visualization relies on the user's ability to have some basic understanding of the data and of what style of chart or graph may be best suited for the task, as well as some familiarity with the charting process of the application. For example, a visualization which displays a relationship between two variables may yield more insight if one of those variables is sub-categorized according to a third variable, as in a stacked bar chart or a clustered column chart. However, to enable a chart to generate such a visualization, the user must navigate an even greater set of chart options in an application's charting functionality.

Becoming proficient in generating visualizations can be a time-consuming process. A user may resort to trial-and-error in pursuit of an optimal visualization of his/her data, generating a number of different versions of a chart before settling on a final version. A user may gain proficiency in generating visualizations based on experience, but this inherently relies on how often the user generates data visualizations. And it is often the case that once a user figures out one way of doing things which is even moderately successful, he or she will not venture to explore ways to improve his or her method, especially when timeliness is a concern. Thus, while there may be more useful ways to display data, alternative types for data visualization which may enable more insight to be gained are under-utilized.

### Overview

Technology is disclosed herein for generating a visualization of data based on an AI-generated data object. In an implementation, an application, such as a data analytics application, receives a natural language input from a user which relates to a table of data in the application. The table includes data organized according to table columns. The application generates a prompt for a large language model (LLM) service which includes the names of the table columns. The prompt tasks the LLM service with selecting columns for the visualization based on the natural language input and the names of the table columns. The prompt tasks the LLM service with generating a response in a JSON format. The application populates the JSON object, which describes the visualization, according to the response. The application then creates visualization based on the JSON object.

In an implementation, the application generates a second prompt for the LLM service which tasks the LLM with selecting a visualization type from a set of visualization types based on the natural language input and the response. The second prompt also tasks the LLM service with returning an object identifier corresponding to the selected visualization type. The application populates the JSON object with the object identifier returned by the LLM service.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for generating a data visualization by an analytics application service with an LLM interface in an implementation.

FIG. 2 illustrates a process for generating a data visualization by an analytics application service with an LLM interface in an implementation.

FIG. 3 illustrates an operational scenario for generating a data visualization by an analytics application service with an LLM interface in an implementation.

FIG. 4 illustrates a process for generating data visualizations by an analytics application service with an LLM interface in an implementation.

FIG. 5 illustrates a workflow for generating a data visualization by an analytics application with an LLM interface in an implementation.

FIG. 6 illustrates an analytics application environment for generating a data visualization in an implementation.

FIG. 7 illustrates a computing system suitable for implementing the various operational environments, architectures, processes, scenarios, and sequences discussed below with respect to the other Figures.

### DETAILED DESCRIPTION

Various implementations are disclosed herein for generating a JSON object using a large language model (LLM) service to create a visualization of data in a data analytics application. In a brief illustration of the technology, a user submits input to the analytics application in relation to data hosted in the application. The application determines that the input relates to creating a data visualization, such as a chart or graph, using two or more columns of data. The application submits the user input along with the column names to the LLM service which selects data (based on the column names) to create a visualization that is responsive to the user's request. The output of the LLM service, generated in a JSON format, is used by the analytics application to populate a JSON object which describes the visualization. The analytics application submits the JavaScript Object Notation (JSON) object to a visualization engine which creates the visualization and renders it in the user interface.

In various implementations of the technology disclosed herein, a user working with dataset or table of data in a user interface of a data analytics application enables a chat pane to open. The data is organized in columns and rows which may be labeled with descriptive names in the column or row headers. In the chat pane, the user submits natural language input relating to data in the chat pane. The chat pane interfaces with a prompt engine of the analytics application which classifies the user input as a request to create a visualization, to edit an existing visualization, to receive assistance with using the application, or some other type of input.

When the input is classified as a request to create a visualization, the prompt engine selects a prompt template based on the classification and builds a prompt for the LLM service. According to the prompt template, the prompt includes the names of the columns in the dataset or table of data and tasks the LLM service to select columns for creating a visualization which is responsive to or satisfies the user's input. The prompt also tasks the LLM service with generating its output in a JSON format to populate a JSON object for creating the visualization. Upon submitting the prompt to the LLM service, the LLM of the LLM service generates a response according to the prompt which is returned to the analytics application.

When the prompt engine receives the response from the LLM service, it parses the output to extract the names of the columns selected by the LLM service and specified in the JSON format to populate the JSON object for the visualization. In an implementation, the prompt engine generates additional prompts from the LLM service based on the user input and responses from the LLM. The exchange of information or “conversation” between the prompt engine and the LLM service forms a prompt chain whereby the LLM is tasked with generating additional parameters or information for the JSON object. For example, the prompt engine may generate a second prompt which tasks the LLM with selecting a type of visualization for the selected columns based on the user input. To generate the second prompt, the prompt engine uses a prompt template which includes a list of visualization types defined in the analytics application. In the prompt template, each type of visualization has a corresponding visualization object identifier to be included in the JSON object. The prompt template tasks the LLM with returning the visualization object identifier corresponding to the selected visualization type.

A data visualization generated by an analytics application can include charts or graphs in which the data is visualized in the form of graphical or geometric elements such as bars, lines, symbols, sectors, boxes, and the like. The types of visualizations which may be included in the prompt can include visualizations which are defined within the analytics application according to unique object identifiers. Such types can include bar chart, horizontal bar chart, line chart, stack bar chart, horizontal stack bar chart, waterfall plot, donut chart, scatter plot, box plot, horizontal box plot, and the like.

The prompt engine may generate other prompts which task the LLM service with making other selections relating to the visualization, such as creating a caption for the visualization to be displayed alongside. For example, the LLM service may be tasked with creating the caption in a natural language format which describes what the visualization shows, such as the type of visualization (e.g., bar chart, scatter plot, pie chart), the data that is included (according to the column names), and the manner in which the data is organized for display (such as in stacked bar chart where the data is categorized according to a third variable).

Still other tasks the LLM service can perform involve configuring elements of the visualization, such as generating a title, selecting fonts or font size for text elements, selecting colors or a color scheme for the geometric elements, selecting symbols used for scatter plots, adding chart lines, adding a legend, adding a regression line, adjusting the range and scale of an axis, adding tick marks to an axis, adjusting a style of the visualization, and the like. Other configuration selections that can be made by the LLM service include the use of color or color gradation as an indicator of a third variable, such as the color of stacked bars in a stacked bar chart. In some scenarios, the prompt may permit the LLM service to recommend a calculated column-a column which, while not present in the table or dataset, can be derived or calculated from one or more existing columns. Prompts which task the LLM service with configuring the visualization include an instruction for the LLM to generate its output in a JSON format. The prompt engine, upon receiving the output, parses the output to extract the JSON elements and updates the JSON object for the visualization with the new JSON elements.

When the user input is classified by the analytics application as a request to edit an existing visualization, the prompt engine may generate a prompt for the LLM service which tasks the LLM with identifying a visualization parameter which relates to the user input and selecting a new value for the parameter responsive to the input. For example, if a column chart is displayed in the user interface and the user keys in, “Make it horizontal,” the analytics application may first classify the input as a request to edit an existing visualization. The analytics application may select a prompt template for submitting the user input along with a description of the existing visualization to the LLM service for revision. The description may include the type of the existing visualization (“Column Chart”) and the data displayed in the visualization by column name (“Product Category” and “Sales”), or it may include selected name/value pairs from the JSON object for the visualization to the LLM service. The LLM service identifies which parameters should be updated and generates revisions responsive to the user's request in a JSON format. Continuing the above example, the LLM service may identify a parameter relating to visualization type in the JSON object and return a new value “Bar Chart.” The prompt engine incorporates updated values in the JSON object of the visualization, and the visualization engine re-renders the visualization based on the updated JSON object.

In the analytics application, the user input may be received by the user keying in the input or speaking the input into a mic which is then translated to a text input by a speech-to-text engine. As the user keys in the input, the analytics application may suggest autocompletions based on the column names or other parameters. The user can select from the suggested autocompletions to generate his/her input.

Large language models (LLMs) are a type of artificial intelligence or deep learning model which processes and generates natural language text. These models are trained on massive amounts of text data and learn to generate coherent and contextually relevant responses given a prompt or input text. LLMs are capable of sophisticated language understanding and generation capabilities due to their trained capacity to capture intricate patterns, semantics and contextual dependencies in textual data. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. Indeed, large language models, such as ChatGPT and its brethren, have been pretrained on an immense amount of data across virtually every domain of the arts and sciences. This pretraining allows the models to learn a rich representation of language that can be fine-tuned for specific NLP tasks, such as text generation, language translation, or sentiment analysis. Moreover, these models have demonstrated emergent capabilities in generating responses which are novel, open-ended, and unpredictable.

A technical effect of the technology disclosed herein includes the ability to engage a user in creating a visualization of his/her data without the user having to become familiar with a menu or hierarchy of visualization or charting options and knowing what type of chart may be best suited for what the user wants to display. Rather, using a chat interface, a user can simply input in natural language form what it is that the user wants to capture from the data, however imprecise the language or uncertain the intent. Once a visualization is created, the user can edit the visualization in a similar manner, submitting a natural language request which is sent to the LLM to identify modifications to the JSON object.

Moreover, by tasking an LLM with making selections to configure the visualization, the process is made more expedient-a single input by the user enables the creation of a visualization which the user can then tweak or modify as necessary to the type of display the user is seeking or to quickly and easily explore alternative ways to visualize the data. By using an LLM to assist in generating the visualization, a wealth of background knowledge in the form of the training data used to train the LLM is made available to the user to figure out the most suitable or most useful visualization for the user's needs.

Further, tasking the LLM according to a series of prompts avoids the problem of exceeding a token limit of the LLM. For example, if the LLM is tasked with creating an entire JSON object for a visualization, the output is likely to exceed the token count of an LLM. Instead, by generating a series of prompts with specific tasks, the JSON object can be created by populating a JSON object based on the series of responses with much smaller token counts. Moreover, asking the LLM to generate a large JSON all at once has a high probability of the JSON including a defect. But by generating the object elements in steps, the validity of the LLM's output can be confirmed at each step. Prompt chaining or sequencing also enables the prompt engine to select prompt templates for follow-on prompts based on the output from the LLM, such as tasking the LLM with making a selection or recommendation based on the particular type of chart that the LLM has suggested.

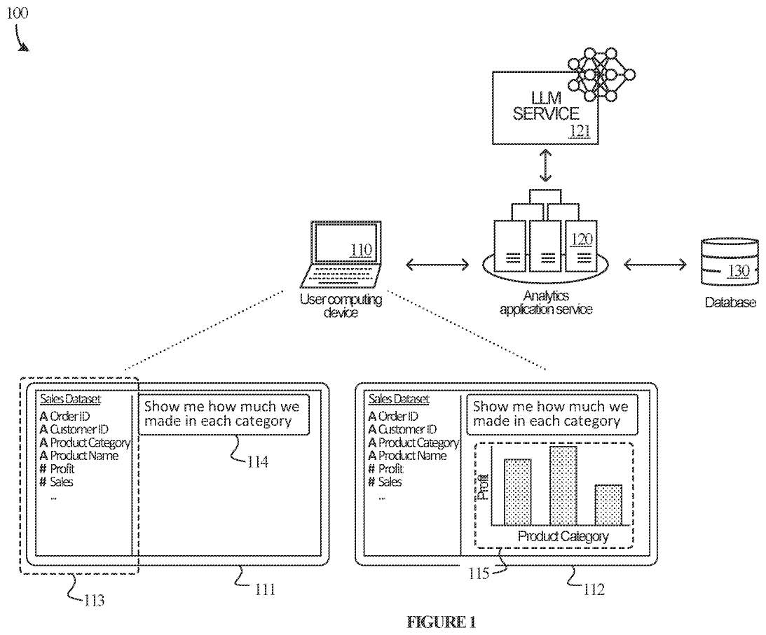

Turning now to the Figures, FIG. 1 illustrates operational environment 100 for generating a visualization of data from a dataset, table of data, or spreadsheet in a data analytics environment in an implementation. Operational environment 100 includes user computing device 110, analytics application service 120, LLM service 121, and database 130. Analytics application service 120 communicates with user computing device 110, LLM service 121, and database 130. Analytics application 120 hosts an analytics application for endpoints such as user computing device 110 which executes an analytics application that provides a local user experience and which interfaces with analytics application service 120. User experiences 111 and 112 of an analytics application hosted by analytics application service 120 are displayed on user computing device 110. The analytics application of analytics application service 120 may be implemented in a natively installed and executed application, and may execute in a stand-alone manner, within the context of another application or in some other manner entirely. LLM service 121 hosts a generative pretrained transformer (GPT) computing architecture such as GPT-3®, GPT-3.5, ChatGPT®, GPT-4, or other GPT model.

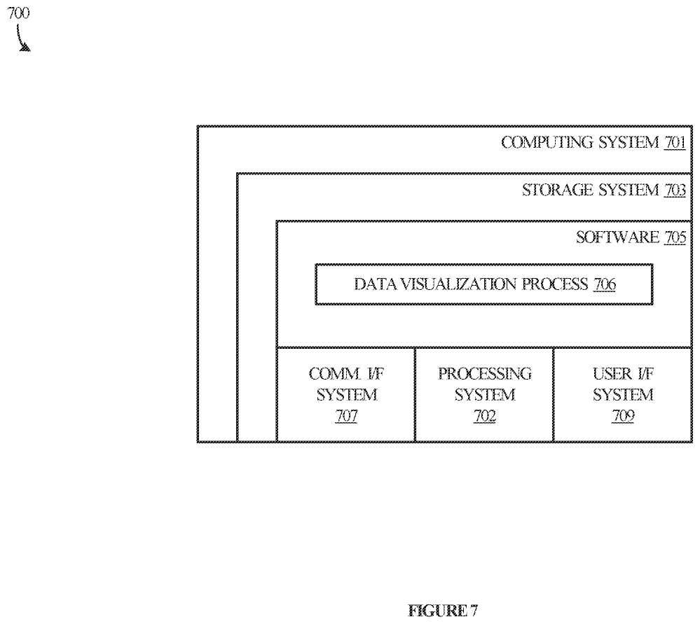

User computing device 110 is representative of a computing device, such as a laptop or desktop computer, mobile computing device, such as a tablet computer or cellular phone, and any other suitable device of which computing device 701 in FIG. 7 is broadly representative. User computing device 110 communicates with analytics application service 120 via one or more internets and intranets, the Internet, wired or wireless networks, local area networks (LANs), wide area networks (WANs), and any other type of network or combination thereof. A user interacting with user computing device 110 interacts with an analytics application of analytics application service 120 via a user interface displayed on user computing device 110. User experiences 111 and 112 are representative of user experiences of an environment for working with data from database 130 and hosted by analytics application service 120, including creating a visualization of the data in an implementation.

Analytics application service 120 is representative of one or more computing services capable of hosting an analytics application and interfacing with user computing device. Analytics application service 120 may be implemented in software in the context of one or more server computers co-located or distributed across one or more data centers. Examples of services or sub-services of analytics application service 120 include—but are not limited to—LLM interaction, database interaction, data handling and analysis, data visualization services, and the like. Analytics application service 120 employs one or more server computers co-located or distributed across one or more data centers connected to user computing device 110. Examples of such servers include web servers, application servers, virtual or physical servers, or any combination or variation thereof, of which computing device 701 in FIG. 7 is broadly representative. Analytics application service 120 may communicate with user computing device 110 via one or more internets, intranets, the Internet, wired and wireless networks, LANs, WANs, and any other type of network or combination thereof.

LLM service 121 is representative of one or more computing services capable of hosting a large language model computing architecture and communicating with analytics application service 120. LLM service 121 may be implemented in the context of one or more server computers co-located or distributed across one or more data centers. LLM service 121 hosts a deep learning AI model, such as ChatGPT®, BERT, ERNIE, T5, XLNet, or other model, which is integrated with the spreadsheet environment associated with application service 120.

Database 130 is representative of a repository for hosting or storing data such as tables, records, databases, files, or the like including structured data or tabular data such as spreadsheet data. Database 130 communicates an instance of a dataset or table of data to analytics application service 120 for analysis and visualization.

In operation, analytics application service 120 receives a dataset (“Sales Dataset”) from database 130 including data organized in tabular form. The dataset includes metadata such as column names or headers. User computing device 110 displays a user experience for an analytics application of analytics application service 120. In user experience 111, the user views column names in selection pane 113 (e.g., “Order ID,” “Customer ID,” etc.) Next to each column name in selection pane 113 is an icon which indicates the type of data in the column, qualitative (e.g., categories or other nominal data) or quantitative.

In user experience 111, the user enters, “Show me how much we made in each category.” User input 114 is received by analytics application service 120 and classified as request to create a visualization of data from the dataset. A prompt engine (not shown) of analytics application service 120 selects a prompt template based on the classification. The prompt template includes an instruction tasking LLM service 121 with selecting data to display in a visualization responsive to user input 114. The prompt template also includes fields to be populated with a user input and a list of column names from the target dataset. The prompt template also includes an instruction tasking LLM service 121 with returning its output in a JSON format (e.g., an array of string values). The prompt engine configures a prompt based on the prompt template and submits it to LLM service 121.

When LLM service 121 receives the prompt, it generates a response which includes a selection of column names from the list provided in the specified format. Analytics application service 120 receives the output and populates a JSON object with the selected column names. For the sake of illustration, it will be assumed that, based on user input 114 and the column names provided and in accordance with its training. LLM service 121 selected columns “Profit” and “Product Category.”

Next, the prompt engine configures a second prompt based on a second prompt template which tasks LLM service 121 with selecting a type of visualization from among a list of available visualization of the analytics application. The second prompt includes user input 114 and the response from the LLM (i.e., the selected columns). The prompt template for the second prompt includes a string value for each type of visualization which LLM service 121 is to return according to the visualization it selects. In an implementation, each string value corresponds to a visualization object identifier defined in the analytics application. Upon submitting the second prompt to LLM service 121, analytics application service 120 receives output from LLM service 121 which includes the string value in a JSON format for selected type of visualization. Analytics application service 120 populates the appropriate field in the JSON object with the string value.

Analytics application service 120 may send other prompts to LLM service 121 to complete other fields of the JSON object. When the JSON object is complete, a visualization engine (not shown) of analytics application service 120 renders visualization 115 as shown in user experience 112.

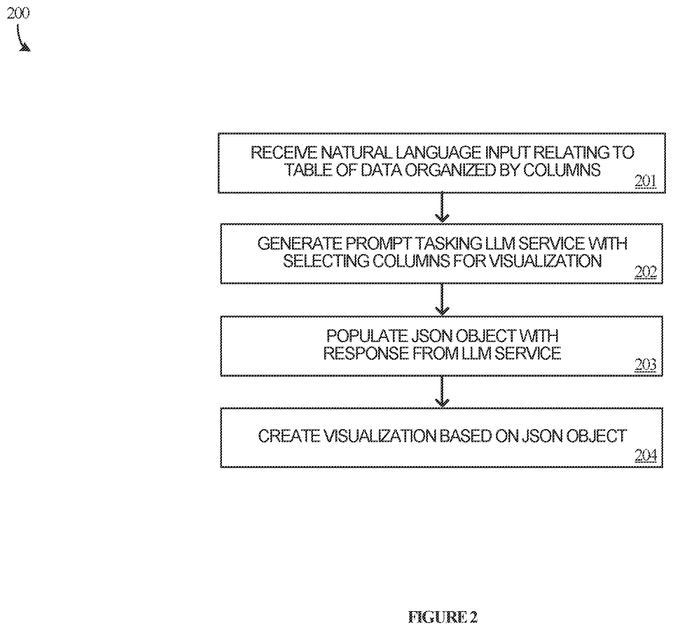

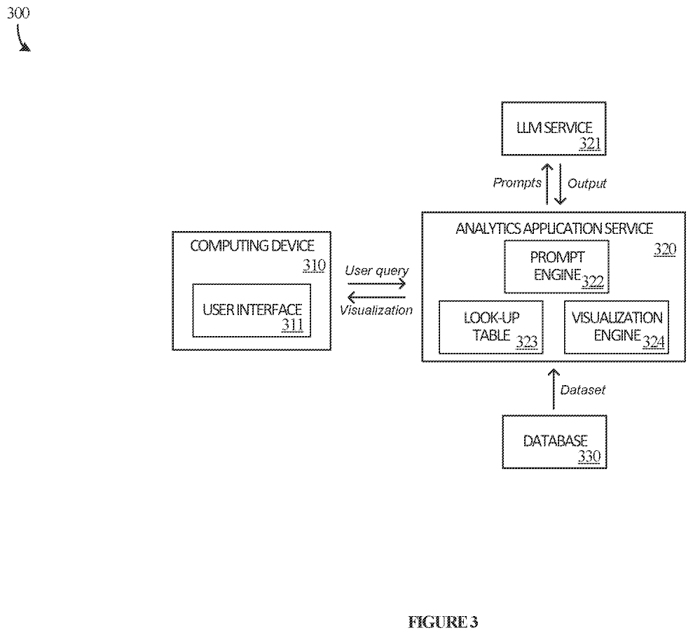

FIG. 2 illustrates a method of operating an analytics application service for generating a visualization using an LLM service in an implementation, hereinafter referred to as process 200. Process 200 may be implemented in program instructions in the context of any of the software applications, modules, components, or other such elements of one or more computing devices. The program instructions direct the computing device(s) to operate as follows, referred to in the singular for clarity.

A computing device receives natural language input relating to a table of data organized by columns (step 201). In an implementation, a user is working with a table of data in an environment of an analytics application. The user keys in a request relating to the data in the table in a user interface displayed in the application environment, such as in a chat pane. The computing device classifies the request as a request for a visualization using two or more columns of data from the table. Based on classifying the request, the computing device selects a prompt template to generate a prompt for an LLM service which will configure the visualization.

The computing device generates a prompt tasking an LLM service with selecting columns for a visualization (step 203). In an implementation, the computing device generates a prompt based on the prompt template. The prompt includes fields to be populated by the user input and metadata from the table, such as a list of column names, a list of row names, a table or dataset name (if any), a filename, and the like. The prompt may also include fields for indicating the type of data in each column, such as whether the column contains quantitative data or qualitative data.

In addition to the fields, the prompt also includes rules or instructions which tell the LLM service what its task is and how the task is to be completed. One rule may be to select columns from the list of column names for a visualization which is responsive to the user input. Another rule may be for the LLM service to provide its output in a particular format, such as a JSON format or as an array of comma-delimited string values enclosed with curly brackets. The prompt may also task the LLM service with providing only the selected columns (by name) and to do nothing else.

The computing device populates a JSON object with the response from the LLM service (step 205). With the prompt created, in an implementation, the computing device submits the prompt to the LLM service and receives a response from the LLM service including output generated according to the prompt. The computing device populates a JSON object with the output from the LLM service. For example, where the output includes the column selections by name in a JSON format, the computing device populates a column name attribute of the JSON object with the output.

The computing device may also populate other attributes of the JSON object based on the columns selected by the LLM service. For example, the JSON object may include an attribute for the unique column identifier akin to a serial number which the computing device uses to reference the columns internally (rather than using the user-created column names). Upon receiving the column selections by name, the computing device may consult a relational database or look-up tool to determine the unique column identifier for the selected columns and populate the appropriate attributes accordingly.

In an implementation, the computing device submits a second prompt which tasks the LLM service with identifying type of visualization to be created. The second prompt may include the selected columns from the output to the first prompt along with the user input. The second prompt may also task the LLM service with selecting a visualization type from among a list of visualization types. The second prompt may also instruct the LLM service to return its selection of visualization type in a particular format, such as a JSON format or a string value which will populate a field in the JSON object. The second prompt may also provide string values for each visualization type and instruct the LLM service to return the string value for the selected visualization type. The string values may be object identifiers by which the computing device generates the visualization.

The computing device may continue to generate prompts relating to creating the visualization. The follow-on prompts may include the user input along with the selections the LLM service has made thus far. In this way, the computing device can generate a visualization which is specially configured to be highly response to the user input rather than generating a generic version of the visualization. In doing so, the user may be presented with a display-ready or publication-ready version of the visualization with minimal input from the user, while also allowing the user the ability to provide further input to edit the visualization as needed.

The computing device creates the visualization based on the JSON object (step 207). In an implementation, the computing device executes a visualization engine which receives the JSON object and generates a visualization based on the selections made by the LLM service incorporated into the JSON object. For example, the visualization engine may generate a blank visualization based on the object identifier, then configure the visualization according to other attributes, such as drawing data from the selected columns of the table, modifying style elements of the table, and so on. With a visualization complete, the computing device displays the visualization in the application environment on the computing device.

With a visualization created, the user may continue to provide input to edit the visualization. The user may, for example, request a different type of visualization or request another set of data be added to the visualization. Upon receiving the user input, the computing device classifies the input as a request to edit the visualization. The computing device selects a prompt template which tasks the LLM service with generating updated values for the JSON object based on the user input and returning the values in a JSON format. Upon receiving the output containing the updated values, the computing device edits the JSON object by updating the appropriate values of the corresponding attributes.

Referring once again to FIG. 1, operational environment 100 illustrates a brief example of process 200 as employed by analytics application service 120 user input 114 and output generated by LLM service 121.

In operational environment 100, a user at computing device 110 submits natural language user input 114 in user experience 111 of the application environment. User input 114 relates to some aspect of tabular data of a dataset hosted by the application. The user may key the input into a chat pane or task pane of the application environment, or the user may speak his/her request into a mic of computing device 110 which translates the audio input into a text.

Analytics application service 120 receives user input 114 from computing device 110 and generates a prompt for LLM service 121. The prompt tasks LLM service 121 with selecting data from the tabular data for a visualization responsive to user input 114. In an implementation, the prompt includes a list of the column names or headers of the tabular data (such as those illustrated in selection pane 113) and instructs LLM service 121 to select columns for a visualization which is responsive to user input 114 and which is based on the column names. In some implementations, the prompt also tasks LLM service 121 with choosing a type of visualization to display the selected columns of data. The prompt also includes an instruction for LLM service 121 to return its selections in a particular format, such as a JSON format or as string values.

To configure the prompt, analytics application service 120 may copy the output from LLM service 121 into the appropriate fields of the JSON object from the visualization will be created. In some instances, analytics application service 120 may look up internal column identifiers for the columns selected by LLM service 121 and include the internal identifiers in the JSON object. Analytics application service 120 may also copy in the visualization type specified in the output from LLM service 121, where LLM service 121 was tasked with returning a unique string value or string identifier corresponding to the selected visualization type.

With the prompt configured, analytics application service 120 submits the prompt to LLM service 121 and receives a response including output generated according to the prompt. Analytics application service 120 populates a JSON object with the output generated by LLM service 121, such as populating column attributes with the selected columns and populating a visualization type attribute with the type of visualization selected by LLM service 121. Analytics application service 120 may generate follow-on prompts to further configure the visualization, such as tasking LLM service 121 with generating a title or a caption for the visualization.

With a JSON object configured for the visualization, analytics application service 120 creates visualization 115 and renders it in the application environment as illustrated in user experience 112. Analytics application service 120 may continue to receive user input relating to visualization 115, such as requests to modify visualization 115. Upon receiving these follow-on requests, analytics application service 120 may configure prompts which direct LLM service 121 to generate updated values for the JSON object according to the follow-on user input, then re-render visualization 115 according to the updated JSON object.

FIG. 3 illustrates operational scenario 300 in which a user submits a request for a visualization of data hosted by an analytics application service in an implementation. Operational scenario 300 includes computing device 310, of which computing device 110 of FIG. 1 is representative, displaying user interface 311. Analytics application service 320, of which analytics application service 120 of FIG. 1 is representative, executes prompt engine 322, look-up table 323, and visualization engine 324. Analytics application service 320 receives a dataset for analysis and visualization from database 330, of which database 130 of FIG. 1 is representative. Analytics application service 120 also communicates with LLM service 321, of which LLM service 121 is representative, by sending prompts to LLM service 321 and receiving output from LLM service 321 based on the prompts.

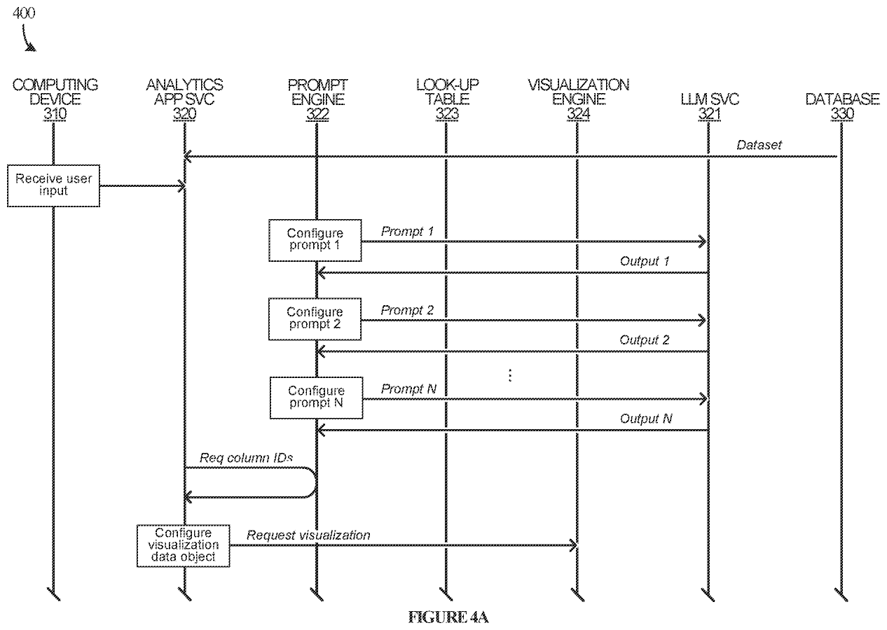

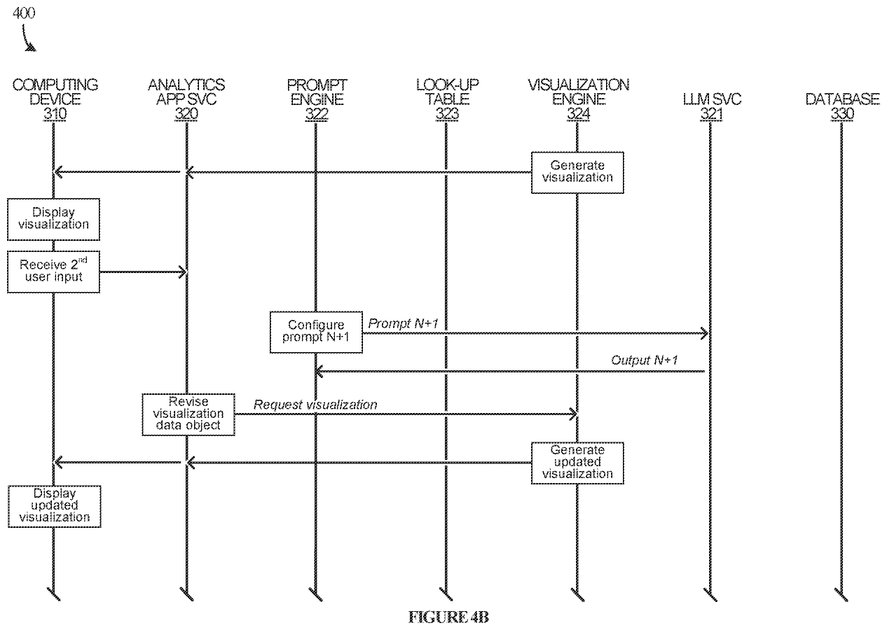

FIGS. 4A and 4B illustrate process 400 for generating and editing a visualization of data by an analytics application service referring to elements of operational scenario 300 in an implementation.

In process 400 in FIG. 4A, analytics application service 320 receives a dataset of tabular data stored by database 330. Computing device 310 receives user input via user interface 311 relating to the tabular data hosted by analytics application service 320. Prompt engine 322 of analytics application service 320 configures Prompt 1 which tasks LLM service 321 with selecting columns of data from the tabular data for a visualization which addresses a request posed in the user input. LLM service 321 generates Output 1 which includes columns selected by LLM service 321 for the visualization. Output 1 includes the column selections in a JSON format as instructed in Prompt 1.

Prompt engine 322 generates Prompt 2 which tasks LLM service 321 with selecting a type of visualization that is suitable for (or most suitable for) the user input. Prompt 2 includes a list of visualization types supported by visualization engine 325 and directs LLM service 321 to include in its output a string value identifier corresponding to the selected visualization type. Prompt engine 322 may also configure other prompts (up to “Prompt N”) for LLM service 321 to configure other aspects of the visualization, such as selections relating to chart options such as tic marks, grid lines, visualization style options, text elements, and the like. In some implementations, a prompt may include output received in response to a previous prompt, while in other scenarios, the prompts are configured independently, that is, without reference to or reliance on the previous responses from the LLM.

In configuring a JSON object for the visualization, analytics application service 320 consults look-up table 323 for unique column identifiers for the columns selected by LLM service 321. For example, while LLM service 321 receives columns by name and returns column selections by name, visualization engine 325 may generate the visualization based on unique, internal column identifiers. To obtain the unique identifiers, analytics application service 320 maintains look-up table 323 in which columns and column names are associated with the unique identifiers. For example, if the user creates a new column in the tabular data, analytics application service 320 creates and stores a unique column identifier for the column in look-up table 323. If the user enters a header or name for the new column, analytics application service 320 stores the column name in association with the unique column identifier. Similarly, if a user changes a column name, analytics application service 320 updates the information in look-up table 323. Thus, when LLM service 321 returns the column names for the selected columns, analytics application service 320 consults look-up table 323 to determine the unique identifiers for those columns.

After receiving output from LLM service 321 in response to the prompts, analytics application service 320 configures a data object for the visualization, such as a JSON object, based on the output. Because Prompts 1 through N task LLM service 321 with generating its output in a JSON format, analytics application service 320 populates the JSON object with the output as it was received from LLM service 321. With the JSON object configured, analytics application service 320 submits the JSON object to visualization engine 324 to create the visualization.

Continuing with process 400 in FIG. 4B, visualization engine 324 receives the JSON object and creates the visualization. Visualization engine 324 returns the visualization to analytics application service 320 which renders the visualization in user interface 311 of computing device 310. With the visualization displayed at computing device 310, the user may wish to modify the visualization in some way. To continue the conversational type of engagement used to create the visualization, the user enters a second user input which includes a request in natural language to modify the visualization in some way.

Analytics application service 320 receives the request and prompt engine 322 configures a new prompt, Prompt N+1, for LLM service 321. Prompt N+1 includes the second user input and tasks LLM service 321 with identifying one or more attributes of the visualization to be modified and one or more new values for the attributes. In some instances, Prompt N+1 includes a list of attributes of the JSON attributes and may also include the current values of those attributes. When LLM service 321 receives Prompt N+1, it generates Output N+1 and returns it to prompt engine 322. Upon receiving Output N+1, analytics application service 320 revises the JSON object to include the new or updated values from Output N+1. Analytics application service 320 sends the revised JSON object to visualization engine 324 to request a revised version visualization. Visualization engine 324 generates a revised version of the visualization and returns it to analytics application service 320. Analytics application service 320 renders the revised version of the visualization in user interface 311.

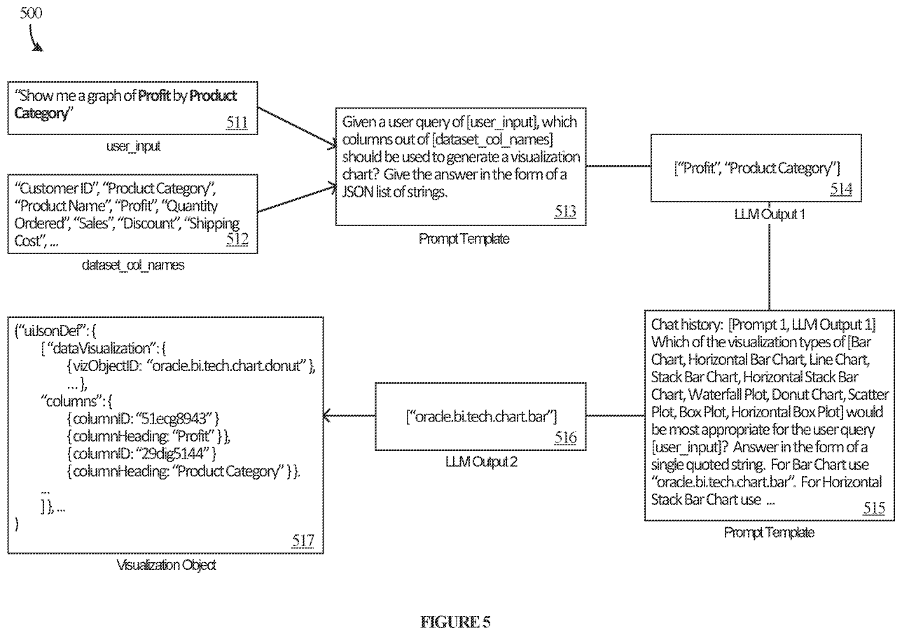

FIG. 5 illustrates workflow 500 for generating a visualization data object, such as a JSON object, for a dataset of tabular data by an analytics application with an LLM interface in an implementation. In workflow 500, a user enters user input 511 in a user interface of an analytics application of an application service of which analytics application service 120 in FIG. 1 is representative. As the user keys in user input 511, the analytics application suggests autocompletions based on the metadata of the tabular data or from other features or operations of the application. The user selects the columns of interest, “Profit” and “Product Category” from the suggested autocompletions and submits user input 511 to the application.

The analytics application classifies user input 511 as a request to create a visualization and selects prompt template 513 to generate a prompt. Prompt template 513 includes instructions by which an LLM is to generate output for creating a visualization and fields to be populated with user input (e.g., user input 511) and column names of the tabular data. The analytics application generates a list of column names 512 from the dataset and populates the appropriate field in the prompt.

Next, in response to submitting the prompt to the LLM, the analytics application receives output 514 which includes a selection of columns from the list supplied in the prompt. In particular, output 514 is generated according to the instructions provided in prompt template 513, such as generating the output in a JSON format.

Next, the analytics application generates a second prompt for the LLM, this time based on prompt template 515. Prompt template 515 tasks the LLM with choosing a visualization type or chart type for the visualization based again on the user input 511 and including the column names specified in output 514. Notably, prompt template 515 includes a list of possible chart types and for each chart type, prompt template 515 includes an object identifier with the LLM is to return in a JSON format.

In response to submitting the second prompt to the LLM, the analytics application receives output 516 with object identifier “oracle.bi.tech.chart.bar.” According to output 516, the LLM has selected a bar chart for the visualization type and so has included the object identifier for a bar chart. In various implementations, the analytics application may continue to submit prompts to the LLM to select other options for the visualization.

Based on output 514 and 516 from the LLM, the analytics application configures visualization object 517. In visualization object 517, the analytics application has populated the column name attributes (“columnHeading”) with the values specified in output 514 and the visualization type attribute (“vizObjectID”) with the value specified in output 516. With visualization object 517 configured or minimally configured, the analytics application submits visualization object 517 to a visualization engine to create the bar chart. Notably, visualization object 517 also includes attributes “columnID” for each of the selected columns, the values of which are unique internal identifiers for those columns.

In various implementations, the two prompts illustrated in workflow 500 may be combined into a single prompt, for example, if the prompt and its output are within the token limit of the LLM. However, it may be preferable to submit two prompts based on the tendency of large language models to perform complex operations when those operations are broken down into smaller, simpler steps. Here, for example, after selecting the columns which are relevant to user input 511, it may be preferable to select the type of visualization knowing which columns will be plotted.

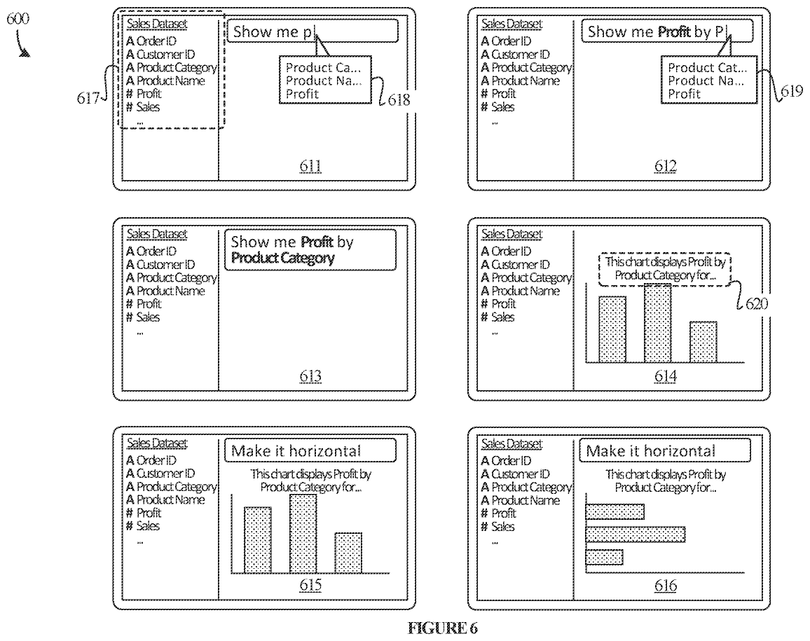

FIG. 6 illustrates an exemplary operational scenario of an analytics application at various stages of operation in an implementation. In operational scenario 600, environments 611-616 include selection pane 617 listing columns of data for the “Sales Dataset.” In environment 611, a user keys an input into a text bar. As the user enters the input, the analytics application surfaces autocompletion suggestions 618 which include the column names of the dataset and filtered according to the input as it is keyed in. The user selects the column “Profit” from the autocompletions suggestions 618 as illustrated in environment 612. As the user continues to key in the input, autocompletion suggests 619 is surfaced based on the text or characters being entered. The user selects Product Category to complete the user input as illustrated in environment 613.

Upon receiving the user input, the analytics application generates a chain or sequence of prompts tasking an LLM with configuring a visualization responsive to the user input. The prompts tasks the LLM to make specific selections, such as deciding which columns of data to graph and which type of chart to create. In some scenarios, a prompt may task the LLM with generating a natural language caption for the visualization. Based on output received from the prompts, the analytics application generates a visualization data object, such as a JSON object, which describes the visualization and by which a visualization engine of the application creates the visualization. As illustrated in environment 614 of operational scenario 600, a bar chart with caption 620 is created based on the output from the LLM.

Continuing the exemplary operational scenario of FIG. 6, after the bar chart is displayed in the environment on the user's computing device, the user enters a second input in environment 615 which impliedly references the bar chart as “it.” The analytics application configures a prompt for the LLM which tasks the LLM with modifying one or more attributes of the visualization. The prompt selected by the analytics engine may be based in part on the visualization being displayed in the user interface and in part on the most recent activity of the user in the environment of the application. The analytics application configures the prompt to include the second user input, “Make it horizontal,” and submits the prompt to the LLM along with instructions tasking the LLM to identify visualization attributes to be modified and new values for those attributes.

In response to the prompt, the LLM identifies, based on its training, that the user wishes to make the chart a horizontal bar chart. Thus, the LLM identifies that the visualization type attribute of the JSON object is implicated and that a new value for the attribute is supplied which corresponds to a horizontal bar chart. The LLM returns output including the attribute to be modified and the new value for the attribute. The analytics application enters the new value for the visualization type attribute of the JSON object and re-renders the visualization, this time as a horizontal bar chart, as illustrated in environment 616.

In FIG. 7, architecture 700 illustrates computing device 701 that is representative of any system or collection of systems in which the various processes, programs, services, and scenarios disclosed herein may be implemented. Examples of computing device 701 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 701 may be implemented as a single apparatus, system, or device or may be implemented in a distributed manner as multiple apparatuses, systems, or devices. Computing device 701 includes, but is not limited to, processing system 702, storage system 703, software 705, communication interface system 707, and user interface system 709 (optional). Processing system 702 is operatively coupled with storage system 703, communication interface system 707, and user interface system 709.

Processing system 702 loads and executes software 705 from storage system 703. Software 705 includes and implements data visualization process 706, which is (are) representative of the data visualization processes discussed with respect to the preceding Figures, such as process 200, process 400, and workflow 500. When executed by processing system 702, software 705 directs processing system 702 to operate as described herein for at least the various processes, operational scenarios, and sequences discussed in the foregoing implementations. Computing device 701 may optionally include additional devices, features, or functionality not discussed for purposes of brevity.

Referring still to FIG. 7, processing system 702 may comprise a micro-processor and other circuitry that retrieves and executes software 705 from storage system 703. Processing system 702 may be implemented within a single processing device but may also be distributed across multiple processing devices or sub-systems that cooperate in executing program instructions. Examples of processing system 702 include general purpose central processing units, graphical processing units, application specific processors, and logic devices, as well as any other type of processing device, combinations, or variations thereof.

Storage system 703 may comprise any computer readable storage media readable by processing system 702 and capable of storing software 705. Storage system 703 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 703 may also include computer readable communication media over which at least some of software 705 may be communicated internally or externally. Storage system 703 may be implemented as a single storage device but may also be implemented across multiple storage devices or sub-systems co-located or distributed relative to each other. Storage system 703 may comprise additional elements, such as a controller, capable of communicating with processing system 702 or possibly other systems.

Software 705 (including data visualization process 706) may be implemented in program instructions and among other functions may, when executed by processing system 702, direct processing system 702 to operate as described with respect to the various operational scenarios, sequences, and processes illustrated herein. For example, software 705 may include program instructions for implementing a data visualization process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 705 may include additional processes, programs, or components, such as operating system software, virtualization software, or other application software. Software 705 may also comprise firmware or some other form of machine-readable processing instructions executable by processing system 702.

In general, software 705 may, when loaded into processing system 702 and executed, transform a suitable apparatus, system, or device (of which computing device 701 is representative) overall from a general-purpose computing system into a special-purpose computing system customized to support a data visualization process in an optimized manner. Indeed, encoding software 705 on storage system 703 may transform the physical structure of storage system 703. The specific transformation of the physical structure may depend on various factors in different implementations of this description. Examples of such factors may include, but are not limited to, the technology used to implement the storage media of storage system 703 and whether the computer-storage media are characterized as primary or secondary storage, as well as other factors.

For example, if the computer readable storage media are implemented as semiconductor-based memory, software 705 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 707 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 701 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method of generating a visualization of data in a data analytics application, comprising:
receiving a natural language input from a user relating to a table of the data in the data analytics application, wherein the table comprises the data organized according to table columns;
generating a prompt for a large language model (LLM) service wherein the prompt includes names of the table columns, wherein the prompt tasks the LLM service with selecting columns of the table columns for the visualization based on the natural language input and the names of the table columns, and wherein the prompt tasks the LLM service with generating a response in a JSON format;
populating a JSON object according to the response, wherein the JSON object describes the visualization; and
creating the visualization based on the JSON object.

2. The method of claim 1, further comprising:
generating a second prompt for the LLM service, wherein the second prompt tasks the LLM service with selecting a visualization type from a set of visualization types based on the natural language input and the response and wherein the second prompt further tasks the LLM service with returning an object identifier corresponding the selected visualization type; and
populating the JSON object with the object identifier.

3. The method of claim 2, further comprising classifying the natural language input as a request to create the visualization and generating the prompt based on a prompt template corresponding to the classification.

4. The method of claim 3, further comprising determining a column identifier corresponding to a column of the selected columns according to a relational database of column identifiers associated with the table.

5. The method of claim 4, wherein creating the visualization comprises creating the visualization according to the selected visualization type, wherein the visualization comprises a graphical representation of data from the selected columns.

6. The method of claim 5, further comprising:
receiving a second user input relating to the visualization;
classifying the second user input as a request for a revised visualization;
submitting a third prompt to the LLM service tasking the LLM service with returning one or more new string values for revising the visualization based on the second user input;
generating an updated data object which includes the one or more new string values; and
creating the revised visualization based on the updated data object.

7. The method of claim 2, wherein the second prompt further tasks the LLM service with generating a natural language caption for the visualization.

8. The method of claim 7, wherein creating the visualization further comprises displaying the natural language caption in association with the visualization.

9. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
receive a natural language input from a user relating to a table of data in a data analytics application, wherein the natural language input relates to creating a visualization of the data and wherein the table comprises the data organized according to table columns;
generate a prompt for a large language model (LLM) service, wherein the prompt includes names of the table columns, wherein the prompt tasks the LLM service with selecting columns of the table columns for the visualization based on the natural language input and the names of the table columns, and wherein the prompt tasks the LLM service with generating a response in a JSON format;
populate a JSON object according to the response, wherein the JSON object describes the visualization; and
create the visualization based on the JSON object.

10. The computing apparatus of claim 9, wherein the program instructions further direct the computing apparatus to:
generate a second prompt for the LLM service, wherein the second prompt tasks the LLM service with selecting a visualization type from a set of visualization types based on the natural language input and the response and wherein the second prompt further tasks the LLM service with returning an object identifier corresponding the selected visualization type; and
populate the JSON object with the object identifier.

11. The computing apparatus of claim 10, wherein the program instructions further direct the computing apparatus to classify the natural language input as a request to create the visualization and generating the prompt based on a prompt template corresponding to the classification.

12. The computing apparatus of claim 11, wherein the program instructions further direct the computing apparatus to determine a column identifier corresponding to a column of the selected columns according to a relational database of column identifiers associated with the table.

13. The computing apparatus of claim 12, wherein to create the visualization, the program instructions direct the computing apparatus to create the visualization according to the selected visualization type, wherein the visualization comprises a graphical representation of data from the selected columns.

14. The computing apparatus of claim 13, wherein the program instructions further direct the computing apparatus to:
receive a second user input relating to the visualization;
classify the second user input as a request for a revised visualization;
submit a third prompt to the LLM service tasking the LLM service with returning one or more new string values for revising the visualization based on the second user input;
generate an updated data object which includes the one or more new string values; and
create the revised visualization based on the updated data object.

15. The computing apparatus of claim 10, wherein the second prompt further tasks the LLM service with generating a natural language caption for the visualization.

16. The computing apparatus of claim 15, wherein to create the visualization, the program instructions further direct the computing apparatus to display the natural language caption in association with the visualization.

17. One or more computer-readable storage media having program instructions stored thereon that, when executed by one or more processors of a computing device, direct the computing device to at least:
receive a natural language input from a user relating to a table of data in a data analytics application, wherein the natural language input relates to creating a visualization of the data and wherein the table comprises the data organized according to table columns;
generate a prompt for a large language model (LLM) service wherein the prompt includes names of the table columns, wherein the prompt tasks the LLM service with selecting columns of the table columns for the visualization based on the natural language input and the names of the table columns, and wherein the prompt tasks the LLM service with generating a response in a JSON format;
populate a JSON object according to the response, wherein the JSON object describes the visualization; and
create the visualization based on the JSON object.

18. The one or more computer-readable storage media of claim 17, wherein the program instructions further direct the computing device to:
generate a second prompt for the LLM service, wherein the second prompt tasks the LLM service with selecting a visualization type from a set of visualization types based on the natural language input and the response and wherein the second prompt further tasks the LLM service with returning an object identifier corresponding the selected visualization type; and
populate the JSON object with the object identifier.

19. The one or more computer-readable storage media of claim 18, wherein the program instructions further direct the computing device to classify the natural language input as a request to create the visualization and generating the prompt based on a prompt template corresponding to the classification.

20. The one or more computer-readable storage media of claim 19, wherein the program instructions further direct the computing device to determine a column identifier corresponding to a column of the selected columns according to a relational database of column identifiers associated with the table.
